(19) United States
(12) Patent Application Publication
(10) Pub. No.: US 2025/0217065 A1
(43) Pub. Date: Jul. 3, 2025

(54) SERIALIZABLE DIRECTORY ITERATOR

(71) Applicant: Dell Products, L.P., Round Rock, TX (US)

(72) Inventor: Ronald Moore, Coalgate, OK (US)

(21) Appl. No.: 18/403,153

(22) Filed: Jan. 3, 2024

(51) Int. Cl. G06F 3/06

(52) U.S. Cl. CPC G06F 3/0655; G06F 3/0604; G06F 3/067

(57) ABSTRACT

Architectures and techniques are described that can save a state of idempotent operations such as directory listing or iteration operations. Thus, these idempotent operations that do not complete can subsequently be continued without rework of the previously completed portions of the operations. The state of the idempotent procedure (e.g., a directory listing) can be saved in a serialized format and can allow the operation or procedure to be continued in a different execution context, including being continued across system, processing, or domain boundaries.

### BACKGROUND

Storage or data service providers typically seek to manage customer data efficiently and securely by maintaining high standards relating to data accessibility, data reliability, scalability, and security. When many different client devices can access and modify the same data on a distributed system, it is beneficial to track the state of the data. To do this, operations are often classified as either idempotent or non-idempotent. Idempotent operations are those that, when reapplied to a target, equal the target, whereas non-idempotent operations are those that, when reapplied to the target do not equal the target. As an example, an operation that sets a target value to one is an idempotent operation because once the operation is performed and the target is set to one, no matter how many times the operation is reapplied to the target, the state of the target does not change. On the other hand, an operation that increments a target value is non-idempotent because each time the operation is applied, the target value increases by one.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram illustrating various data service clusters in accordance with certain embodiments of this disclosure;

FIG. 2 depicts a schematic block diagram illustrating an example node of the data service provider architecture in more detail in accordance with certain embodiments of this disclosure;

FIG. 3 depicts a schematic block diagram illustrating an example device that can store a state of a directory listing operation in a serialized data structure in accordance with certain embodiments of this disclosure;

FIG. 4 depicts a schematic block diagram illustrating various examples of the directory iteration data in accordance with certain embodiments of this disclosure;

FIG. 5 depicts a schematic block diagram illustrating various examples of the communication channel data in accordance with certain embodiments of this disclosure;

FIG. 6 depicts a schematic block diagram illustrating an example device that can resume a directory listing operation based on the serialized data structure in accordance with certain embodiments of this disclosure;

FIG. 7 illustrates an example method that can provide for saving a state of a directory listing operation in a serialized data structure in accordance with certain embodiments of this disclosure;

FIG. 8 illustrates an example method that can provide for additional functionality or elements relating to saving a state of a directory iteration operation in a serialized data structure in accordance with certain embodiments of this disclosure;

FIG. 9 illustrates a block diagram of an example distributed file storage system that employs tiered cloud storage in accordance with certain embodiments of this disclosure; and

FIG. 10 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

As indicated in the background section, operations are often classified as either idempotent or non-idempotent. Although idempotent rework is guaranteed not to change the state of the data, such can be expensive nonetheless in terms of resource utilization. In this regard, data service providers classify operations according to idempotence in the context of producing save states of data because non-idempotent operations cannot be reapplied without changing the state of the data, whereas idempotent operations can be. Because data service providers can readily reapply idempotent operations, saving state data is not as critical with idempotent operations as with non-idempotent operations, because idempotent operations can simply be reapplied if need be, which is sometimes referred to as idempotent rework. However, although idempotent rework is guaranteed not to change the state of the data, such can be expensive nonetheless in terms of resource utilization.

As a representative illustration, listing a directory is one example of an idempotent operation, but for large directories, particularly when the directory listing includes file transfers, such can waste a significant amount of resources. In the context of directory listings, or other suitable idempotent operations, the disclosed subject matter can operate to avoid idempotent rework, which can significantly improve resource consumption.

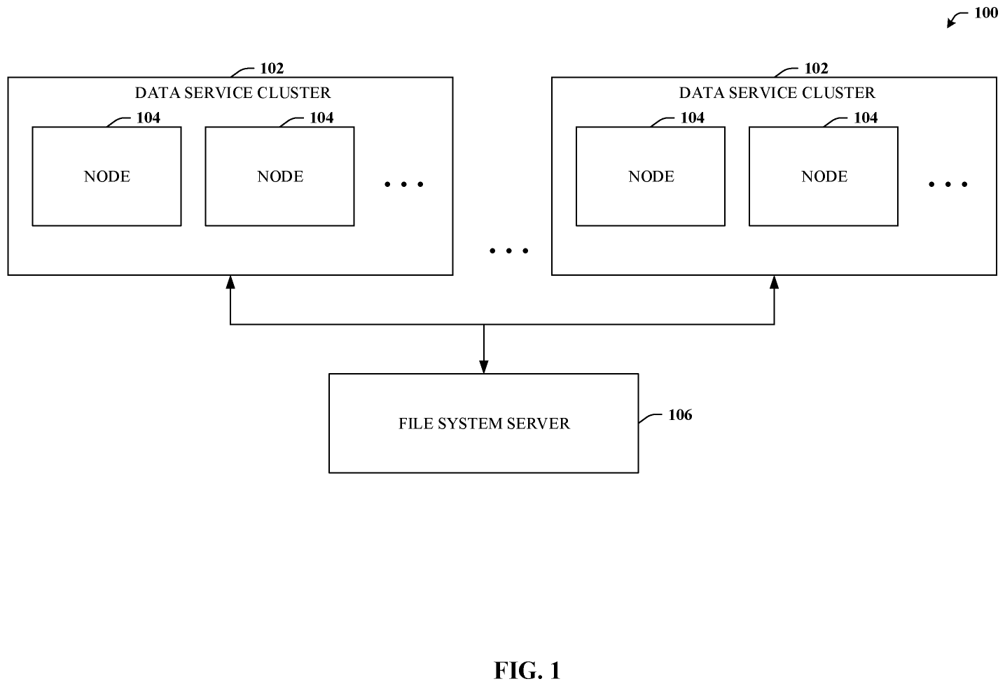

To provide additional context, consider an example architecture of a data service provider, illustrated in connection with FIG. 1. FIG. 1 depicts a schematic block diagram 100 illustrating various data service clusters 102 in accordance with certain embodiments of this disclosure. Data service clusters 102 can represent various clusters of a network attached storage (NAS) system, which is used herein as representative, but it is appreciated that other suitable storage systems may be used such as storage area network (SAN) or others.

Each data service cluster 102 can comprise any suitable number of nodes 104. Each node 104 (e.g., a NAS node) can serve customer or client requests relating to stored data or other services. For example, a directory listing request can be routed to a file system server 106, which can maintain the file system according to a defined protocol. As a representative example, the disclosed techniques can employ network file system (NFS), but it is appreciated that other suitable file system protocols can be suitable such as, for example, Common Internet File System/Server Message Block (CIFS/SMB) or others.

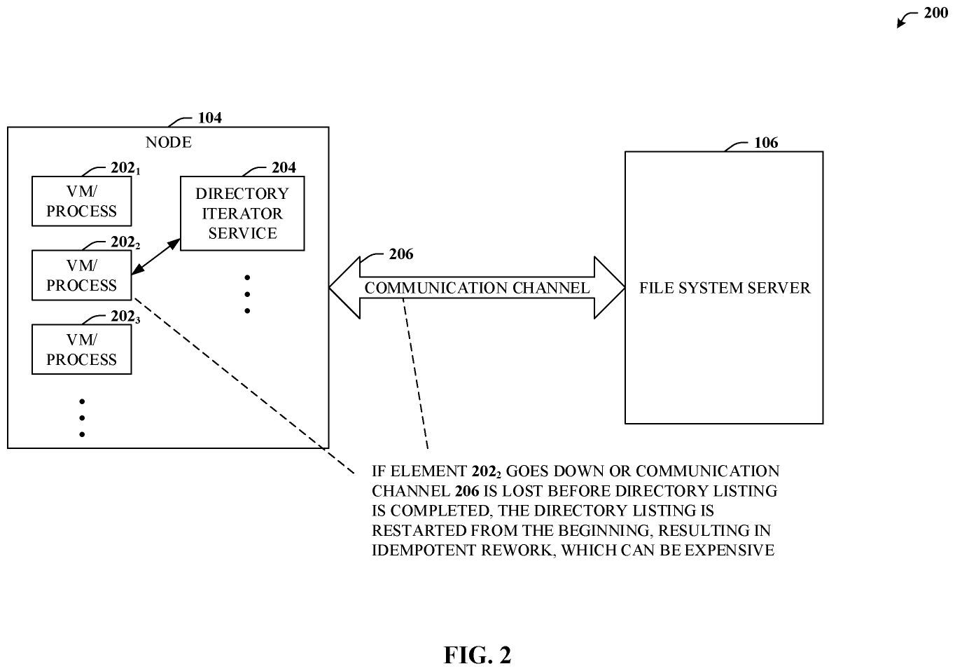

Referring now to FIG. 2, schematic block diagram 200 is depicted illustrating an example node 104 in more detail in accordance with certain embodiments of this disclosure. As illustrated, a given node 104 can execute many different instances of processing elements or devices illustrated here as virtual machines and/or processing elements 202, any of which can serve clients or perform operations with respect to the data service.

Additionally, node 104 can comprise a directory iterator service or device 204 as well as other services or devices to perform other functions or operations. Generally, a directory iterator can be a programming construct or device having functionality that allows a program to traverse and iterate over the contents of a directory. In file systems, a directory (e.g., sometimes referred to as a folder) can be a container that holds files and possibly other directories (e.g., sometimes referred to as subdirectories).

In operation, a directory iterator (e.g., directory iterator service or device 204) can provide a way for an entity (e.g., a client, service, program . . . ) to access the files and subdirectories within a given directory such as that managed by file system server 106. For instance, a directory iterator can allow the program to retrieve information about each file, such as its name, size, modification date, and other relevant attributes. This is particularly useful for tasks like file management, searching, or processing multiple files within a directory. The specific implementation of a directory iterator can vary depending on the programming language and the operating system, but typical directory iterators can perform one or more of the following:

Initialization: The directory iterator can be initialized with the path to the directory to be traversed. Iteration: The directory iterator can provide a mechanism to iterate through each entry (file or subdirectory) within the specified directory. Retrieval of Information: For each iteration, the directory iterator can allow the requesting entity to retrieve information about the current file or subdirectory, such as its name, type, and attributes. End of Directory: The directory iterator can signal when the end of the directory is reached, allowing the requesting entity to conclude the iteration.

Many programming languages provide libraries or built-in functions for working with directory iterators. These libraries can abstract the underlying operating system-specific details, making it easier for developers to write cross-platform code for directory traversal.

However, many directory iterators have certain shortcomings. For example, as previously noted, iterating a directory is frequently accompanied with file transfers relating to the data within a given directory. While directory iterators exist, previous directory iterators cannot cross process or system boundaries. While they can be used to iterate over a given file system if directed at a mounted remote file system, if the mount is lost or iteration needs to continue in an execution context other than where it was established (e.g., another node 104 of a distributed system), the iteration cannot be resumed, but rather must be restarted from the beginning. To illustrate, suppose virtual machine 2022 interacts with directory iterator service 204 to perform a directory listing. Such can invoke communication with file system server 106 via communication channel 206.

When the iteration is requested the target directory can be listed and the associated files or other data transferred. This operation locks the associated directory (and subdirectories) until completed. However, if node 104 (or element 2022) crashes or otherwise goes down, or the connection to file system server 106 (e.g., communication channel 206) goes down or is lost before completion, then it is generally not known how much work was performed.

Hence, the data service provider generally waits until node 104 is back up and running or communication channel 206 re-established before the directory iteration can restart. Moreover, as the data service provider will typically endeavor to synchronize all data across many different system or processing domains, but it is not known how much of the directory listing was completed, this issue is traditionally dealt with by rework of idempotent operations. That is, since the directory iteration is an idempotent operation, the directory listing is restarted from the beginning.

As noted, such can cause severe performance penalties for the data service provider, particularly with wide directories. Thus, being able to synchronize the work already performed would be a welcome advance. Furthermore, being able to synchronize the work performed for a directory listing and have the work execute across all domains without rework would be another welcome advance. For instance, having the capability to initiate a directory iteration on processing element 2022 of node 104 and complete the directory iteration elsewhere, be it a different processing element of node 104, a different node 104 of the same cluster 102, or even a different node 104 on a different cluster 102.

Certain file system protocols such as NFS allow the capability to stream directory listings, and these may incorporate previous directory iterators that suffer from the above-mentioned shortcomings. However, the information available from the streaming directory listings can be leveraged to implement a serializable directory iterator that can resume a directory iteration (e.g., without idempotent rework), even if such crosses platform boundaries, even if the directory iteration is resumed on a different node or one with a different operating system.

### Example Systems

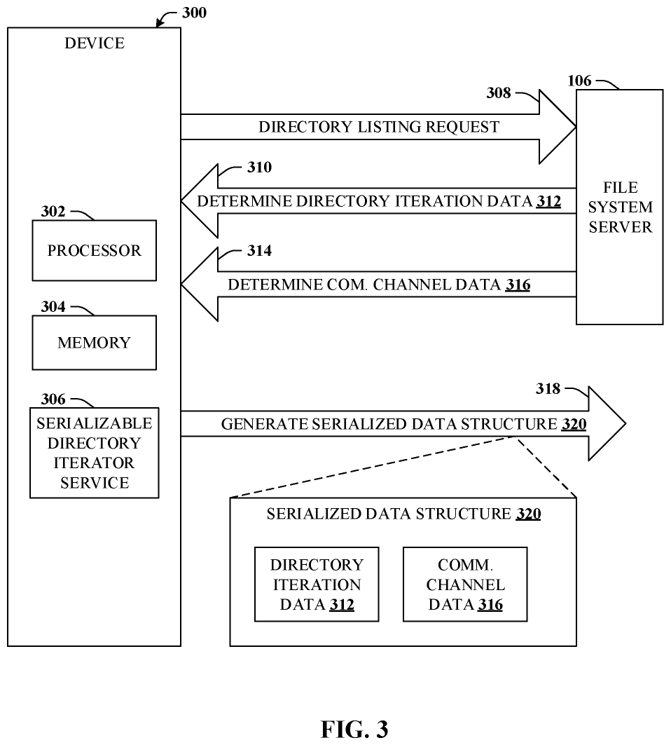

With reference now to FIG. 3, a schematic block diagram is depicted illustrating an example device 300 that can store a state of a directory listing operation in a serialized data structure in accordance with certain embodiments of this disclosure. As a result, the state of the directory listing operation can be packaged up and shipped elsewhere so that the directory listing operation can be continued in a different execution context such as on a different node or processing element without idempotent rework of any portion of the directory listing operation that was completed where the operation was initiated. In some embodiments, device 300 can be a serializable directory iterator service device that provides the indicated functionality so processing elements that execute on a node of a data or storage platform such as a NAS node.

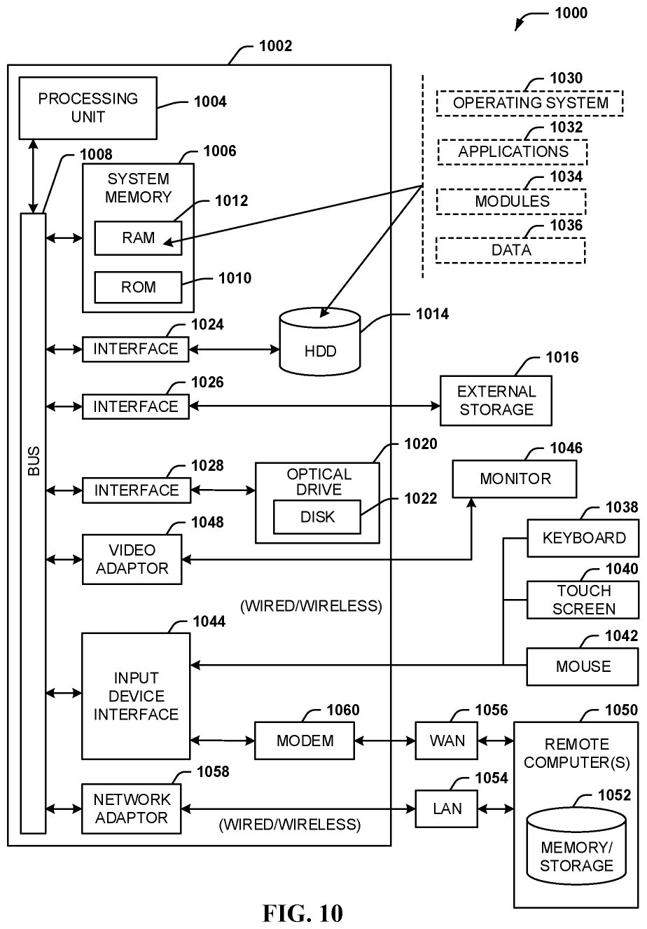

Device 300 can comprise a processor 302 that, potentially along with serializable directory iterator service 306, can be specifically configured to perform functions associated with serializable and/or state-saving functions of a directory iteration or listing. Device 300 can also comprise memory 304 that stores executable instructions that, when executed by processor 302, can facilitate performance of operations. Processor 302 can be a hardware processor having structural elements known to exist in connection with processing units or circuits, with various operations of processor 302 being represented by functional elements shown in the drawings herein that can require special-purpose instructions, for example, stored in memory 304 and/or serializable directory iterator service 306. Along with these special-purpose instructions, processor 302 and/or serializable directory iterator service 306 can be a special-purpose device. Further examples of the memory 304 and processor 302 can be found with reference to FIG. 10. It is to be appreciated that device 300 or computer 1002 can represent a server device or a client device of a network or data services platform and can be used in connection with implementing one or more of the systems, devices, or components shown and described in connection with FIG. 3 and other figures disclosed herein.

As illustrated at reference numeral 308, a directory listing request can be received by file system server 106 (e.g., an NFS server). This directory listing request can request a directory listing or directory iteration with respect to some target directory and can be transmitted to file system server 308 by device 300 or another suitable source.

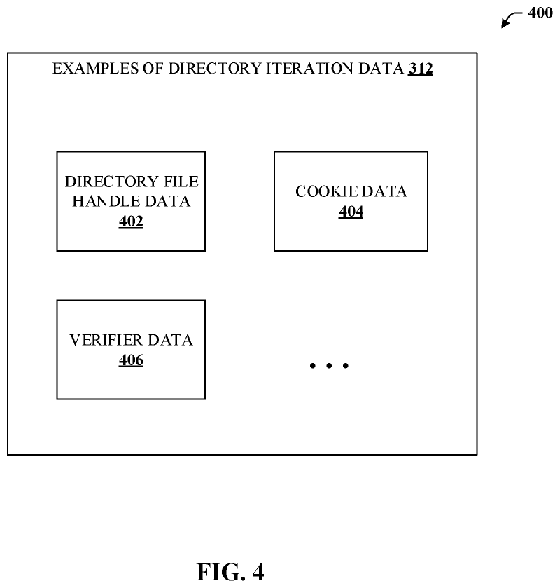

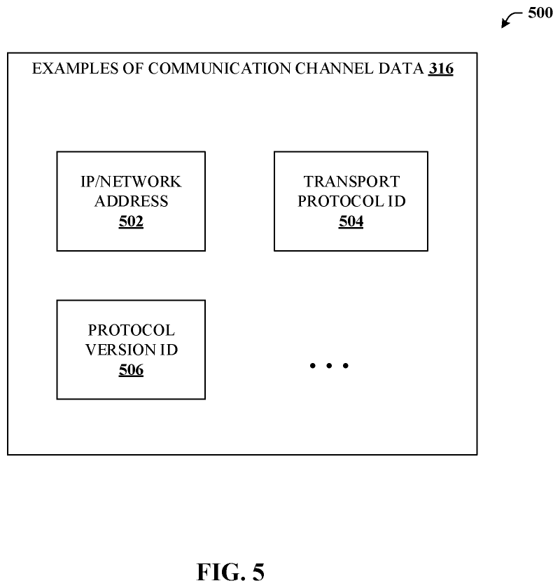

In response to the directory listing request, device 300 can perform operations directed to collecting and/or determining certain pertinent information. For example, at reference numeral 310, device 310 can determine directory iteration data 312, which is further detailed in connection with FIG. 4. In addition, at reference numeral 314, device 300 can determine communication channel data 316, which is further detailed in connection with FIG. 5.

By way of introduction, directory iteration data 312 can relate to information used by file system server 106 when performing a directory listing and/or iteration. For systems that provide streaming directory listings such as NFS servers, or other suitable systems, such can be available via calls to file system server 106. Yet, regardless of how directory iteration data 312 is obtained or otherwise determined, or on the particular system in which these techniques are implemented, directory iteration data 312 can have certain characteristics that are further described with reference to FIG. 4.

While still referring to FIG. 3, but turning now as well to FIG. 4, a schematic block diagram 400 is depicted illustrating various examples of directory iteration data 312 in accordance with certain embodiments of this disclosure. For example, directory iteration data 312 can include some reference to, or identifier of the target directory that is being iterated. For NFS systems, such is commonly referred to as a directory file handle and is illustrated here as directory file handle data 402.

Directory iteration data 312 can further comprise cookie data 404. Cookie data 404 can be information that indicates a last element, within the target directory, that was iterated. For example, during execution of the directory iteration operation, the last element (e.g., cookie data 404) can represent how far in the directory listing the operation has progressed and/or identify the last file or other suitable element listed prior to the directory iteration operation being stopped for any reason.

Directory iteration data 312 can further comprise verifier data 406. Verifier data 406 can indicate whether a state of the target directory being iterated has changed on file system server 106. Provided the state of the target directory has not changed, then it can be recognized that the directory listing is still valid and/or synchronized with file system server 106. Otherwise, the directory listing operation can terminate or various other actions can be taken to synchronize. It is understood that in addition to the above-mentioned elements, directory iteration data 312 can include other suitable elements.

As mentioned, existing directory iterators, including streaming directory iterators, can perform directory listing operations. However, in order to do so, the directory listing is completed in the same execution context where the directory listing began. Such presumes that the same node (e.g., node 102) and processing instance (e.g., virtual machine/processing element 202) functions properly during the entire operation and that for the entire operation a stable communication channel (e.g., communication channel 206) is maintained with file system server 106.

However, when moving execution domains, such as moving across node boundaries or process boundaries, a given communication channel cannot be guaranteed. Hence, in addition to the directory iteration data 312, device 300 can further utilize communication channel data 316, which is described in more detail with reference to FIG. 5.

While still referring to FIG. 3, but referring now as well to FIG. 5, a schematic block diagram 500 is depicted illustrating various examples of communication channel data 316 in accordance with certain embodiments of this disclosure. For example, communication channel data 316 can comprise Internet Protocol (IP)/Network address 502. IP/Network address 502 can be indicative of an IP address or other suitable network address associated with file system server 106 (e.g., an NFS server).

Communication channel data 316 can further comprise transport protocol ID 504. Transport protocol ID 504 can be indicative of or identify the transport protocol that was used for that particular communication channel. Representative examples can include transmission control protocol (TCP), user datagram protocol (UDP), or another suitable protocol.

Furthermore, communication channel data 316 can further include protocol version ID 506. Protocol version ID 506 can be indicative of a version associated with the particular protocol used by file system server 106. For example, if file system server 106 is an NFS server, then protocol version ID 506 can indicate a version of the NFS protocol. It is understood that in addition to the above-mentioned elements, communication channel data 316 can include other suitable elements.

Still referring to FIG. 3, at reference numeral 318, device 300 can generate serialized data structure 320. As illustrated, serialized data structure 320 can comprise all or a portion of directory iteration data 312 and all or a portion of communication channel data 316. These and other suitable data can be placed in serialized data structure 320 in a serial data format such that can be parsed or retrieved individually or in discrete form.

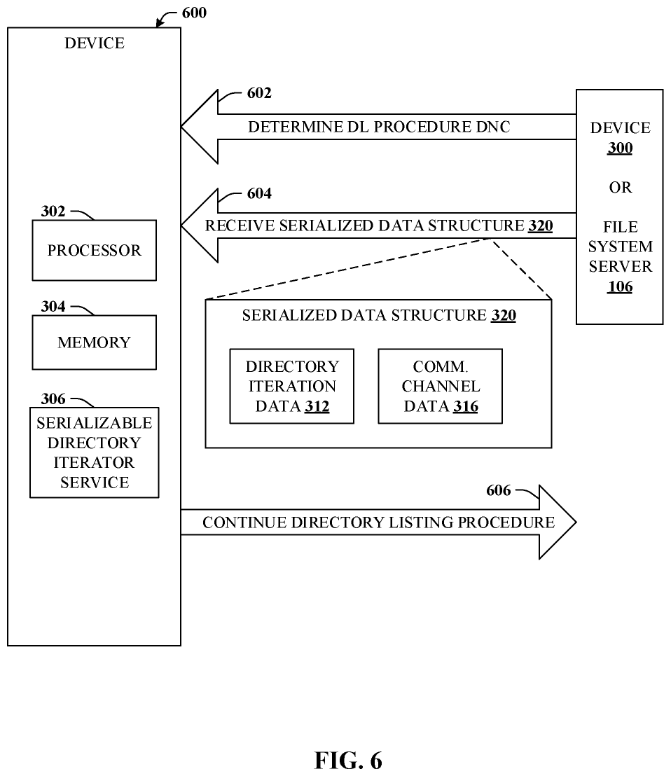

More generally, it can be observed that serialized data structure 320 can include a past NFS (or other file system protocol) cookie in the form of cookie data 404 and verifier in the form of verifier data 406, which can indicate how much of the directory listing has been completed and that the directory listing is still valid. That structure can be serialized and can be sent to another execution context, which is further detailed in connection with FIG. 6. In other words, prior to the directory listing operation completing, this serialized data structure 320 can be transmitted to any suitable remote entity, which can then resume the directory listing operation without rework of the idempotent operations already performed in the initial execution context.

Once the serialized data (e.g., serialized data structure 320) is in the other execution context (e.g., another processing element 202 or another node 104), that data can be de-serialized and the directory listing operation can be resumed regardless of the state of the communication channel (e.g., communication channel 206). If the communication channel is down or non-existent, a communication channel can be created. If there is an existing communication channel to the correct file system server 106, that existing communication channel can be used.

Moreover, by leveraging input iterator concepts included in certain programming languages, parsing or unpacking serialized data structure 320 can be extremely efficient. For example, after de-serialization where the directory listing is to be resumed, one can simply use a standard programming language range-based for loop to continue execution in the new context. Such can dramatically reduce code complexity as well as potential for defects in how the iterator is used.

With reference now to FIG. 6, a schematic block diagram is depicted illustrating an example device 600 that can resume a directory listing operation based on the serialized data structure in accordance with certain embodiments of this disclosure. Hence, a directory listing operation can be initiated in one execution context (e.g., by device 300), and resumed without idempotent rework in one or more different execution contexts (e.g., by device 600). In some embodiments, device 600 can be the same or similar to device 300. For example, device 600 can comprise processor 302, memory 304, and serializable directory iterator service 306 as detailed in connection with FIG. 3. However, it is appreciated that device 600 can exist or be executing on a different node 104 than device 300 and can run or can be instantiated according to different protocols or operating systems than device 300.

As indicated at reference numeral 602, device 600 can determine that a directory listing procedure did not complete. This directory listing procedure can be one determined to have been executing on a different device. For example, the directory listing procedure can be started as explained in connection with device 300 of FIG. 3, but for some reason was not completed on device 300. In some embodiments, the directory listing procedure can be continued on one or more intermediate devices.

At reference numeral 604, device 600 can receive serialized data structure 320, the creation of which was detailed previously. Serialized data structure 320 can be received from device 300, file system server 106, or from another suitable device or entity. As explained, serialized data structure 320 can include directory iteration data 312 and communication channel data 316 in a serial data form.

Device 600 can unpack or de-serialize serialized data structure 320 and, at reference numeral 606, device 600 can continue the directory listing procedure that was began or at least partially executed by a different device and/or a different execution context. Appreciably, continuing the directory listing procedure can done with idempotent rework of the operations that were previously performed on the different device and/or the different execution context.

### Example Methods

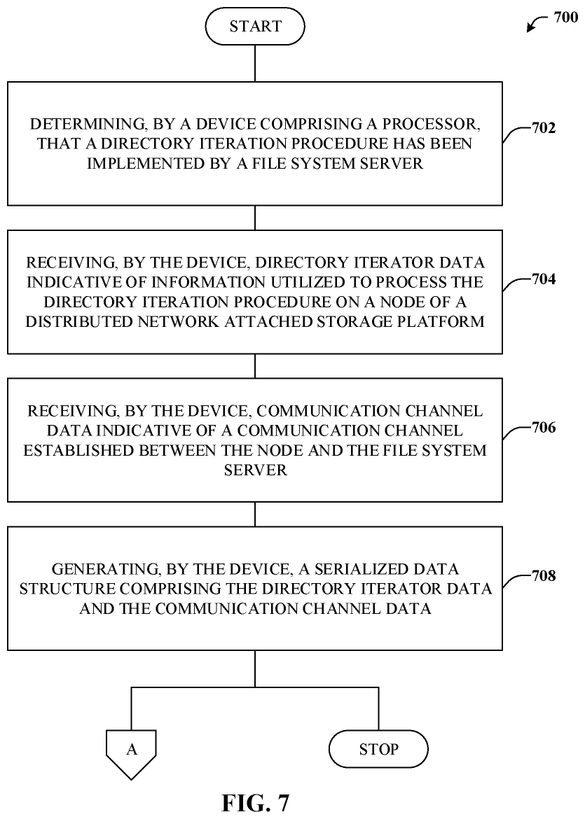

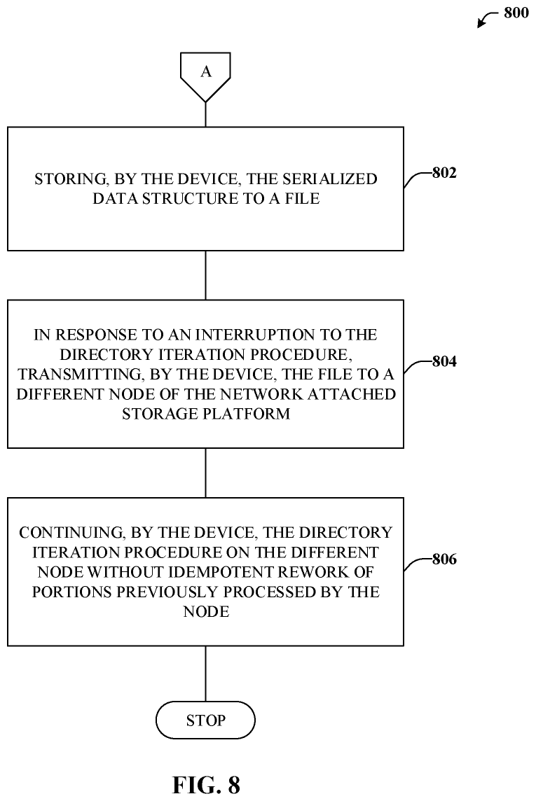

FIGS. 7 and 8 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 7, exemplary method 700 is depicted. Method 700 can provide for saving a state of a directory listing operation in a serialized data structure in accordance with certain embodiments of this disclosure. While method 700 describes a complete method, in some embodiments, method 700 can include one or more elements of method 800, as illustrated by insert A.

At reference numeral 702, a device comprising a processor can determine that a directory iteration procedure has been implemented by a file system server. It is understood that directory iterations or listings can be accompanied by file transfer operations such as when mounting a remote directory or drive. Hence, while the directory iteration can be considered idempotent work, in the event of the directory iteration procedure terminating for some reason before completion, repeating the idempotent work previously performed can be expensive. To avoid this rework, even of idempotent operations, the state of the directory iteration procedure can be saved in a serialized format as explained herein.

For instance, at reference numeral 704, the device can receive directory iteration data. This directory iteration data can be indicative of information utilized to process the directory iteration procedure on a node of a distributed network attached storage platform.

In some embodiments, the directory iteration data can comprise directory file handle data, cookie data, and verifier data. The directory file handle data can represent information that refers to or identifies the directory being iterated. The cookie data can indicate where in the directory the procedure currently is, such as an indication of the last item processed by the procedure. The verifier data can be indicative of a current state of the target directory and/or an indicator about the last modification to the target directory.

At reference numeral 706, the device can receive communication channel data. This communication channel data can be indicative of a communication channel established between the node where the directory iteration procedure is being performed and the file system server. In some embodiments, the channel communication data can comprise IP address or network address information, a transport protocol identifier, and a protocol version identifier, as detailed previously in connection with FIG. 5.

At reference numeral 708, the device can generate a serialized data structure. This serialized data structure can comprise all or a portion of the directory iteration data and all or a portion of the communication channel data. Method 700 can terminate in some embodiments, or proceed to insert A in other embodiments, which is further detailed in connection with FIG. 8. Appreciably, prior to completion of the directory iteration procedure, this serialized data structure can this serialized data structure can be transmitted to a different execution context, where the directory iteration procedure can be completed or at least continued from the last execution state, which is further detailed in connection with FIG. 8.

Turning now to FIG. 8, exemplary method 800 is depicted. Method 800 can provide for additional functionality or elements relating to saving a state of a directory iteration operation in a serialized data structure in accordance with certain embodiments of this disclosure. For example, while method 700 can save the state of the directory iteration procedure state, method 800 can relate to storing or transmitting that data to different execution contexts, where further execution of the directory iteration procedure can be continued without rework of portions already processed in a former execution context.

For example, at reference numeral 802, the device introduced at reference numeral 702, comprising a processor, can store the serialized data structure to a file or a network transmissible form if not already in said form.

At reference numeral 804, the device can, in response to an interruption to the directory iteration procedure, transmit the file to a different node of the network attached storage platform.

At reference numeral 806, the device can continue the directory iteration procedure. Continuation of the directory iteration procedure can take place in a different execution context, such as on a different node without idempotent rework of portions previously processed by the node.

### Example Operating Environments

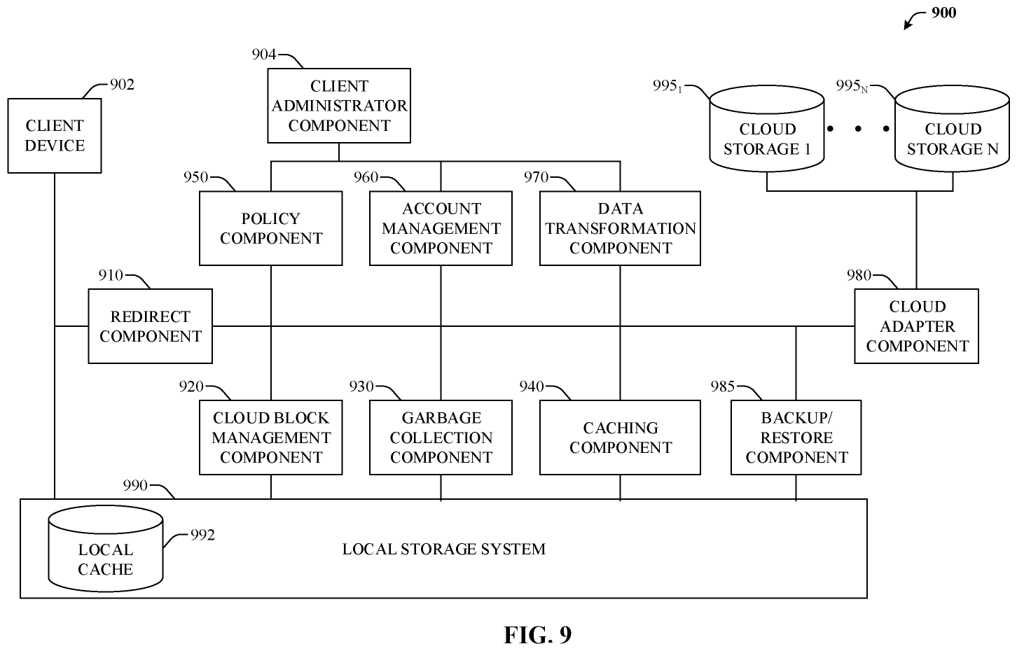

To provide further context for various example embodiments of the subject specification, FIGS. 9 and 10 illustrate, respectively, a block diagram of an example distributed file storage system 900 that employs tiered cloud storage and block diagram of a computer 1002 operable to execute the disclosed storage architecture in accordance with example embodiments described herein.

Referring now to FIG. 9, there is illustrated an example local storage system including cloud tiering components and a cloud storage location in accordance with implementations of this disclosure. Client device 902 can access local storage system 990. Local storage system 990 can be a node and cluster storage system such as an EMC Isilon Cluster that operates under OneFS operating system. Local storage system 990 can also store the local cache 992 for access by other components. It can be appreciated that the systems and methods described herein can run in tandem with other local storage systems as well.

As more fully described below with respect to redirect component 910, redirect component 910 can intercept operations directed to stub files. Cloud block management component 920, garbage collection component 930, and caching component 940 may also be in communication with local storage system 990 directly as depicted in FIG. 9 or through redirect component 910. A client administrator component 904 may use an interface to access the policy component 950 and the account management component 960 for operations as more fully described below with respect to these components. Data transformation component 970 can operate to provide encryption and compression to files tiered to cloud storage. Cloud adapter component 980 can be in communication with cloud storage 1 995₁ and cloud storage N 995_{N}, where N is a positive integer. It can be appreciated that multiple cloud storage locations can be used for storage including multiple accounts within a single cloud storage location as more fully described in implementations of this disclosure. Further, a backup/restore component 985 can be utilized to back up the files stored within the local storage system 990.

Cloud block management component 920 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 920 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 960 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 920 based on a list of mappings that the cloud block management component 920 manages. For example, each stub can be associated with an account, and the cloud block management component 920 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 980 manages the sending and receiving of data to and from the cloud service providers. The cloud adapter component 980 can utilize a set of APIs. For example, each cloud service provider may have provider specific API to interact with the provider.

A policy component 950 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 930. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 930 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 940 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 920, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 940 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 940 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 970 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 985 can transfer a copy of the files within the local storage system 990 to another cluster (e.g., target cluster). Further, the backup/restore component 985 can manage synchronization between the local storage system 990 and the other cluster, such that, the other cluster is timely updated with new and/or modified content within the local storage system 990.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various example embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1094 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations, comprising:
in response to a directory listing request that requests a directory listing from a file system server:
determining directory iteration data indicative of information utilized to process the directory listing request; and
determining communication channel data indicative of a communication channel to the file system server; and
generating a serialized data structure comprising the directory iteration data and the communication channel data.

2. The device of claim 1, wherein the file system server is a network file system server.

3. The device of claim 1, wherein the directory iteration data comprises at least one of:
directory file handle data that identifies a directory being iterated;
cookie data that indicates a last element, within the directory, that was iterated; or
verifier data that indicates whether a state of the directory being iterated has changed on the file system server.

4. The device of claim 1, wherein the communication channel data comprises a network address of the file system server.

5. The device of claim 1, wherein the communication channel data comprises a transport protocol identifier that indicates a type of transport protocol used by the file system server for the directory listing request.

6. The device of claim 1, wherein the communication channel data comprises a version identifier indicative of a protocol version utilized by the file system server.

7. The device of claim 1, wherein the communication channel data comprises: a network address of the file system server, a transport protocol identifier that indicates a type of transport protocol used by the file system server for the directory listing request, and a version identifier indicative of a protocol version utilized by the file system server.

8. The device of claim 1, wherein the operations further comprise storing the serialized data structure to a file.

9. The device of claim 7, wherein the operations further comprise, in response to an interruption of the communication channel to the file system server prior to completion of the directory listing request, transmitting the file to a different device configured to continue the directory listing without idempotent rework of previously processed portions of the directory listing request.

10. A device, comprising:
a processor; and
a memory that stores executable instructions that, when executed by the processor, facilitate performance of operations, comprising:
determining that a directory listing procedure executing on a different device did not complete;
receiving a serialized data structure comprising:
directory iteration data indicative of information obtained from a file system server during the directory listing procedure executed by the different device; and
communication channel data indicative of a communication channel to a file system server; and
based on the serialized data structure, continuing the directory listing procedure without idempotent rework of previously processed portions of the directory listing procedure.

11. The device of claim 10, wherein the file system server is a network file system server.

12. The device of claim 10, wherein the directory iteration data comprises at least one of:
directory file handle data that identifies a directory being listed;
cookie data that indicates a last element, within the directory, that was listed; or
verifier data that indicates whether a state of the directory being listed has changed on the file system server.

13. The device of claim 10, wherein the communication channel data comprises a network address of the file system server.

14. The device of claim 10, wherein the communication channel data comprises a transport protocol identifier that indicates a type of transport protocol used by the file system server for the directory listing request.

15. The device of claim 10, wherein the communication channel data comprises a version identifier indicative of a protocol version utilized by the file system server.

16. The device of claim 10, wherein the communication channel data comprises at least two of: a network address of the file system server, a transport protocol identifier that indicates a type of transport protocol used by the file system server for the directory listing request, or a version identifier indicative of a protocol version utilized by the file system server.

17. A method, comprising:
determining, by a device comprising a processor, that a directory iteration procedure has been implemented by a file system server;
receiving, by the device, directory iteration data indicative of information utilized to process the directory iteration procedure on a node of a distributed network attached storage platform;
receiving, by the device, communication channel data indicative of a communication channel established between the node and the file system server; and
generating, by the device, a serialized data structure comprising the directory iteration data and the communication channel data.

18. The method of claim 17, further comprising storing, by the device, the serialized data structure to a file.

19. The method of claim 18, further comprising, in response to an interruption to the directory iteration procedure, transmitting, by the device, the file to a different node of the network attached storage platform.

20. The method of claim 19, further comprising continuing, by the device, the directory iteration procedure on the different node without idempotent rework of portions previously processed by the node.
